(19) United States
(12) Patent Application Publication
(10) Pub. No.: US 2005/0034493 A1
(43) Pub. Date: Feb. 17, 2005

(54) Locking system for motor vehicles

(75) Inventors: Reinhard Wittwer, Heiligenhaus (DE); Mirko Schindler, Velbert (DE); Dirk Hansen-Ruther, Ennepetal (DE)

Correspondence Address: Friedrich Kueffner, Suite 910, 317 Madison Avenue, New York, NY, 10017, US

(73) Assignee: Huf Hulsbeck & Furst GmbH & Co. KG

(21) Appl. No.: 10/626,169

(22) Filed: Jul. 23, 2003

(30) Foreign Application Priority Data
Jul. 23, 2002 (DE) 102 33 511.7

(51) Int. Cl. B60R 25/02

(52) U.S. Cl. 70/186

(57) ABSTRACT

A locking system includes an actuator which serves to control the engine and which can be moved between a home position associated with the parked state of the vehicle and at least one working position associated with the state in which the vehicle is being driven. An actuator blocking element normally secures the home position of the actuator. A locking bar of an anti-theft device of the vehicle, however, also belongs to the locking system. This locking bar can be changed between a release position and a locking position and is secured in its release position by a locking bar blocking element. A connection is provided between the actuator blocking element and the locking bar blocking element. This connection ensures that, when the locking bar blocking element is active, the actuator blocking element is inactive and, conversely, when the locking bar blocking element is inactive the actuator blocking element is active. When the locking bar is in the locking position, the locking bar blocking element also serves the important function of being the reason that the actuator blocking element is held in this active position and thus that the actuator is arrested in the home position. The reason for this is a locking shoulder, against which the locking bar blocking element is supported.

### BACKGROUND OF THE INVENTION

1. Field of the Invention

The present invention relates to a locking system with a device for driving authorization.

2. Description of the Related Art

The device for access authorization used here can be designed in any desired way. For example, it can be designed as a so-called “keyless-go system” or in the form of an electronic or mechanical key. To start an internal combustion engine in a vehicle or, to speak in general terms, to control an engine of any type, an actuator is used, which can be moved manually into various positions to activate different functions of the engine. There is always a “home position”, which characterizes the parked state of the vehicle, in which the engine is at rest. There are also one or more working positions of the actuator, which, for example, correspond to the state in which the vehicle is being driven or to the state in which the internal combustion engine is being started.

To secure the actuator in its home position, a first blockade element is provided, which will be called an “actuator blocking element” in the following to differentiate it from another element. The actuator blocking element is deactivated when the access authorization system responds, and it then allows the actuator to move into its working position or positions.

To secure the vehicle against theft, a locking bar is provided, which can be moved between two positions and which, in one of its positions, namely, the locking position, acts on the steering system of the vehicle or prevents the actuation of the hand-operated engine transmission selector. The anti-theft system could also function by interrupting the fuel supply to the internal combustion engine. To steer the vehicle or to be able to operate it, the locking bar must be moved into its release position. Although this could be done mechanically, it is usually done in modern motor vehicles by means of an electric motor.

The locking bar is also positively secured in its release position. This is done by means of a second blockade element, which will be called the “locking bar blocking element” in the following to differentiate it from the previously mentioned first blockade element.

In a known locking system of this type (EP 0 999 968 B1), an electromagnetic locking mechanism is used as a locking bar blocking element. This electromagnetic locking mechanism, however, also functions simultaneously as the actuator blocking element, which locks the actuator in its home position. When the electromagnetic locking mechanism fails, the two elements of the locking system, namely, both the actuator and the locking bar, are no longer simultaneously secured in this known locking system, which can have fateful results.

Separate, electrically controlled components are usually used to block the actuator and to block the locking bar, for which purpose additional electronic control components are required, namely, separate sensors, separate actuators, and the associated logic control circuits. It is necessary to use not only sensors which must recognize and differentiate among the home position and the various working positions of the actuator, but also sensors for determining the release position and the locking position of the locking bar so that the logic control circuits can be informed of these positions. Finally, as said above, separate actuators are required, one to block the actuator and another to block the locking bar. The operation of these actuators is controlled by the associated logic control circuits. These many electronic components are expensive. When many electric components are present, furthermore, the danger is greater that one of the electronic components will fail, which thus renders the known locking system unusable.

### SUMMARY OF THE INVENTION

The invention is based on the task of developing a reliable locking system of the type indicated above which can be produced a low cost.

In accordance with the present invention, a mechanical connection between the two blockade elements ensures an exact coupling of their changeover movements between their active and inactive positions with respect to the actuator and the locking bar, these movements thus occurring as mirror images of each other. When the locking bar blocking element has been activated to secure the locking bar in the release position, the connection between the two elements automatically ensures that the actuator blocking element is in its inactive position and therefore allows the actuator to be moved between its home position and its working positions. When, in contrast, the actuator blocking element is active and is thus securing the actuator in its home position, then, because of the existence of the connection, the locking bar blocking element is necessarily deactivated. Thus the locking bar is no longer held in its release position and can be returned in motorized or electrical fashion to its locking position. The changeover movements of the two blocking elements are therefore coordinated exactly with each other.

Via the connection between the two elements, furthermore, it is possible for at least the active position of the actuator blocking element to be arrested in the home position of the actuator by the locking bar blocking element. For this purpose it is sufficient for the locking bar blocking element to be supported by a shoulder when the locking bar is in its locking position, because this supporting effect, via the connection, results in the previously mentioned arresting of the actuator blocking element with respect to the actuator. This shoulder, which is to be referred to as the “locking shoulder”, is able to move when the locking bar is moved from one position to the other and in the simplest case forms a part of the locking bar. This has the effect of making it impossible for the blockade elements to be operated incorrectly in the locking system according to the invention.

As a result of this coupling between the blockade elements on the two sides, it is possible to eliminate the sensors on at least one of the terminal elements to be connected to each other, e.g., to eliminate the sensors which are normally necessary to detect the position of the locking bar. In any case, however, the interconnected blockade elements according to the invention reduce the number of actuators required.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 shows a schematic longitudinal cross section of a first locking system which works without a key and which is therefore called as “keyless-go system”, with an actuator and a locking bar according to the invention in a first working phase in which the actuator is in the home position and the locking bar is in the locking position;

FIGS. 2 and 3 show cross sections through the actuator shown in FIG. 1 along cross-sectional lines II-II and III-III, respectively;

FIG. 4 shows a plan view of the actuator of FIG. 1 from the perspective of the arrow IV;

FIG. 5 shows another operating phase of the first exemplary embodiment shown in FIG. 1, in which the actuator is in its working position and the locking bar is in the release position;

FIGS. 6, 7, and 8 show, in analogy to FIGS. 2, 3, and 4, cross sections and a plan view of the actuator of FIG. 5 along the cross-sectional lines VI-VI and VII-VII, respectively, and from the perspective of the arrow VIII;

FIG. 9 shows a second exemplary embodiment of the invention in a view and position similar to those of FIG. 1;

FIG. 10, in analogy to FIG. 4, shows a plan view of the actuator shown in FIG. 9;

FIG. 11 shows the second exemplary embodiment of FIG. 9 after the components have arrived in the positions according to FIG. 5;

FIG. 12, in analogy to FIG. 6, shows a cross section through the actuator of FIG. 11 along the cross-sectional line XII-XII in that figure;

FIG. 13 shows only the actuator of a third exemplary embodiment of the invention in longitudinal cross section, the actuator being in its home position corresponding to that of the first exemplary embodiment according to FIG. 1, where the locking bar (not shown) can have the same design as that shown in FIG. 1;

FIG. 14 shows a plan view of the actuator shown in FIG. 13 from the perspective of the arrow XIV in FIG. 13;

FIG. 15 shows another longitudinal cross section, perpendicular to the longitudinal cross section of FIG. 13, through the actuator shown in FIG. 13 along the discontinuous cross-sectional line XV-XV of FIG. 13;

FIG. 16 shows a detail of the actuator shown in FIG. 13 when this is in its other operating phase, namely, the working position, which corresponds to the operating phase of the first exemplary embodiment shown in FIG. 5, where the associated locking bar can be designed in the same way as that shown in FIG. 5 of the first exemplary embodiment;

FIG. 17 shows a flat development of the control curve provided on the actuator of FIG. 13, the plan view of which is given in FIG. 15;

FIG. 18 shows a fourth exemplary embodiment of the invention in a view and in an operating phase corresponding to those of FIG. 1;

FIG. 19 shows the exemplary embodiment of FIG. 18 in another operating phase, after an electronic key has been inserted into the actuator but while the actuator itself is still in its home position as shown in FIG. 18; and

FIG. 20 shows the fourth exemplary embodiment in a third operating phase, which corresponds to that of FIG. 5 of the first exemplary embodiment.

### DESCRIPTION OF THE PREFERRED EMBODIMENTS

All four exemplary embodiments of the locking system according to the invention are illustrated in the drawings in the form of two assemblies 10, 20, which can be any desired distance from each other. This locking system works with keyless access authorization and is therefore known as a “keyless-go system”. In this case, the person authorized to use the vehicle has a mobile identification transmitter, which communicates with a stationary identification receiver in the vehicle. The first assembly is an anti-theft lock 10, which, in the present case, consists of an electrical steering wheel lock. The second assembly is an engine control unit 20, which, in the present case, is used in conjunction with an internal combustion engine and is therefore designed as an ignition starter switch.

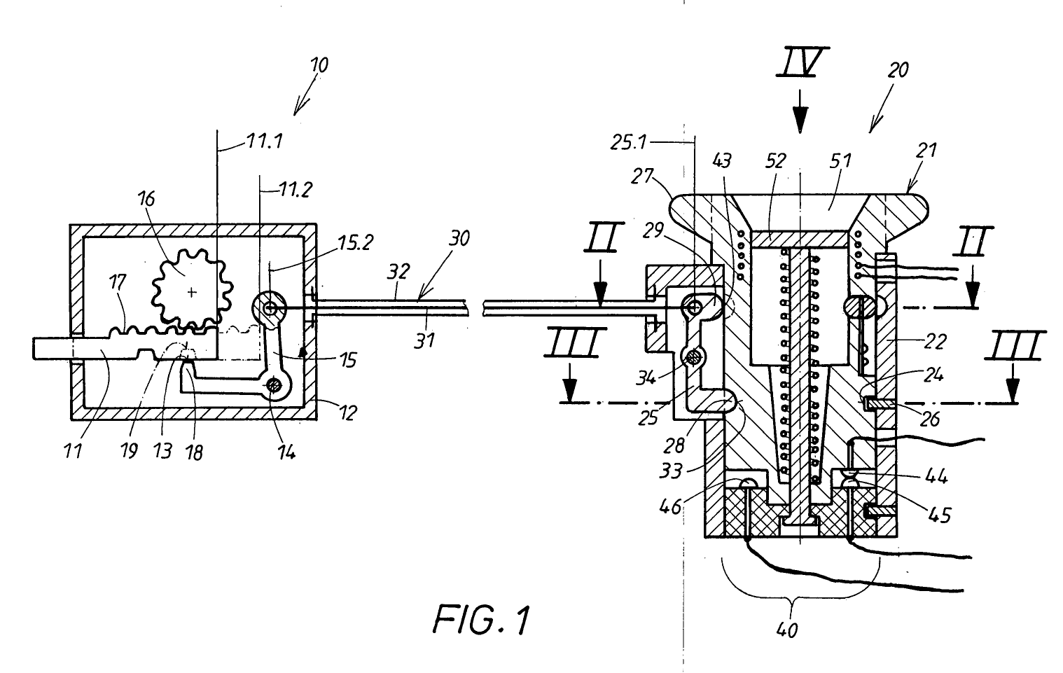

The electrical steering wheel lock 10 has a locking bar 11, which, in FIG. 1, is in its locking position, indicated by the auxiliary line 11.1. In the locking position 11.1, the locking bar 11 has traveled out from the housing 12 and has engaged in a nonrotatable opening (not shown) in a steering column. It is then no longer possible to turn the steering wheel. The locking bar 11 has an extension, which, of course, moves concomitantly with the locking bar 11, and a first shoulder 13, against which, in this position 11.1, a blockade element 15 is supported. For the purpose of differentiation from a similar element in the area of the engine control system 20, this blockade element 15 is called the “locking bar blocking element”, and the shoulder 13 is called the “locking shoulder”. The locking bar blocking element 15 is designed here as an angled lever, which is supported with freedom to pivot at the point 14 in the housing 12. A spring-loading device (not shown) can ensure that one of the angle arms of the locking bar blocking element 15 remains resting against the locking shoulder 13. Because of a connection acting on the locking bar blocking element 15, this support of the element has the result that the engine control unit 20 cannot be actuated.

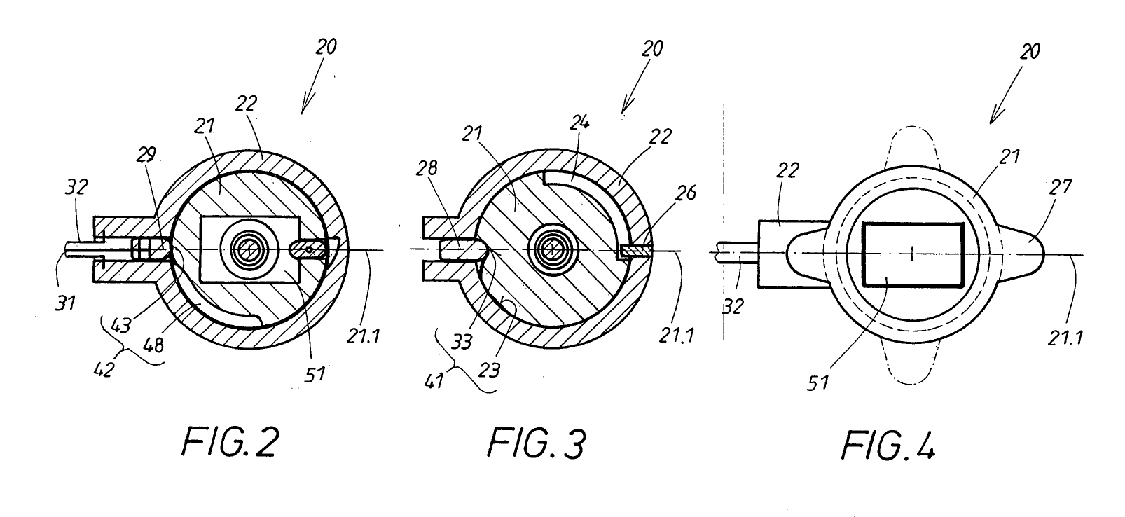

The engine control unit 20 has, first, an actuator 21, which, in the present exemplary embodiment, consists of a rotor, which is held with freedom of rotation inside a stationary stator 22. So that they cannot move axially with respect to each other, the rotor 21 and the stator 22 are connected by a circumferential groove 24 and a pin 26, which engages in the groove, as can be seen in FIG. 3. Groove 24 and pin 26 limit the degree to which the rotor can turned; the handle 27 shown in FIG. 4 is provided so that the rotor can be turned manually. FIGS. 1-4 show a first starting position of the rotor 21, which is labeled in the cross sections of FIGS. 2-4 by the auxiliary line 21.1 and which is called the “home position” of the actuator 21 below.

This home position 21.1 of the rotor 21 is secured by an additional blockade element 25, which, in the following, as already mentioned, is to be called the “actuator blocking element”. This also consists in the present case of a two-armed lever with angled arms, which is pivotably supported at point 34 in the stator 22. The ends of the arms are designated in FIG. 1 by the numbers 28 and 29. A control surface 41, 42, the exact shape of which can be seen in the cross-sectional views of FIGS. 2 and 3, is assigned to each of the ends 28, 29. In the case of the rotor 21, these control surfaces are in the form of peripheral contours in the appropriate axial planes. They are designed in the following way.

The first control surface 41 assigned to arm end 28 comprises a radial opening 33 in the rotor 21, which continues by way of a ramp to a circumferential area 23, which is referred to below as the “working shoulder” for reasons which will become clear later. In the home position 21.1 according to FIGS. 1 and 3, the one arm end 28 just fits into the radial opening 33. This engagement can be achieved by means of a positive control process, which includes the other arm end 29. As can be seen in FIGS. 1 and 2, the second arm end 29 is situated on a circumferential area 43 of the rotor 21, which belongs to the previously mentioned second control surface 42. This provides for additional positive control of the two blockade elements 15, 25 to be described in greater detail below.

In the present case, the mechanical connection 30 consists of a Bowden cable with a strand 31, which is flexible in and of itself and which connects the two blockade elements 15, 25 to each other for movement in common. The strand 31 is located inside a sheath 32 belonging to the Bowden cable, this sheath being attached at one end to the locking bar housing 12 and at the other end to the stator 22. The strand 31 can be actuated by both pulling and pushing and establishes a dimensionally stable, play-free connection between the two blockade elements 15, 25. This has the result that the support of the locking bar blocking element 15 on the locking shoulder 13 by way of the push-pull strand 31 ensures that the arm end 28 of the actuator blocking element 25 is positively arrested in the radial opening 33. It is therefore now impossible for the rotor 21 to move. The rotor 21 is a component of a switch 40 with various movable and resting contacts 44-47. In the home position 21.1, the electrical connection to the engine is interrupted.

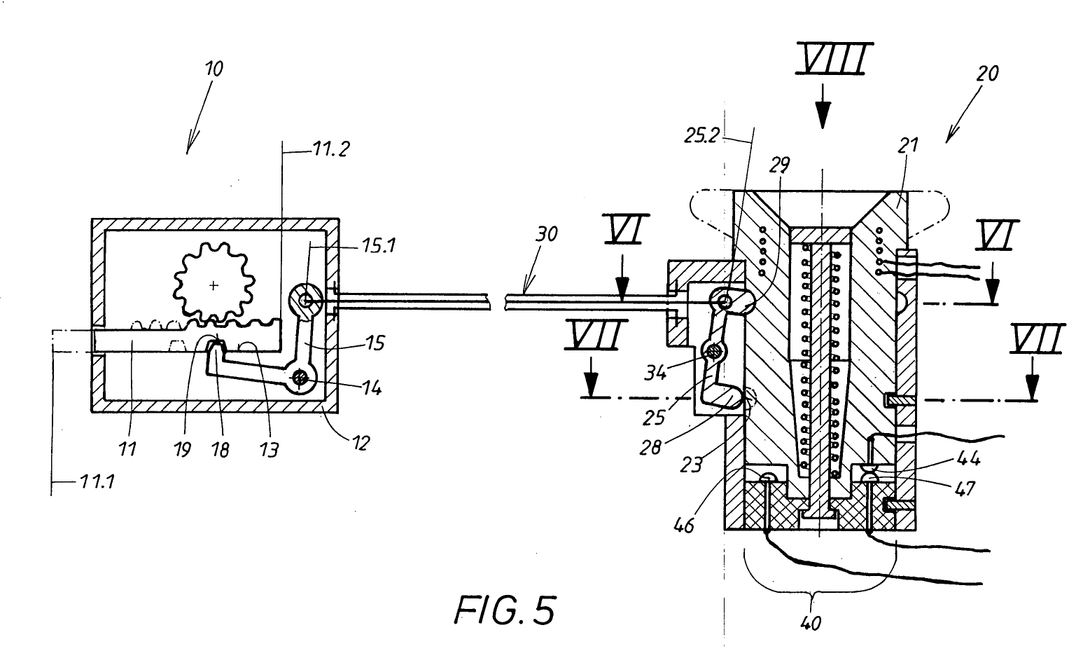

When the access authorization system designed here in the “keyless-go” manner recognizes that the authorized user would like to start the vehicle, the locking bar 11 is changed over into its other position, i.e., into the release position indicated in dash-dot line, designated by the auxiliary line 11.2 in FIG. 1, by way of an electric motor, at the output of which a gear wheel 16 is located. There is thus a positive connection between this electric motor and the locking bar 11. In the present case, the gear wheel 16 of the electric motor engages in a toothed rack 17 provided on the locking bar 11. What happens then is indicated in dash-dot line in FIG. 1. In the release position 11.2, the locking bar 11 is drawn into the housing and releases the steering column (also not shown in FIG. 5). The vehicle can now be steered. Then, as illustrated in dash-dot line in FIG. 1, a locking recess 19 is aligned with the locking end 18 on the locking bar blocking element 15. In any case the locking shoulder 13, as can be seen in FIG. 5, has moved away and the previously mentioned support of the locking bar blocking element 15 is no longer present.

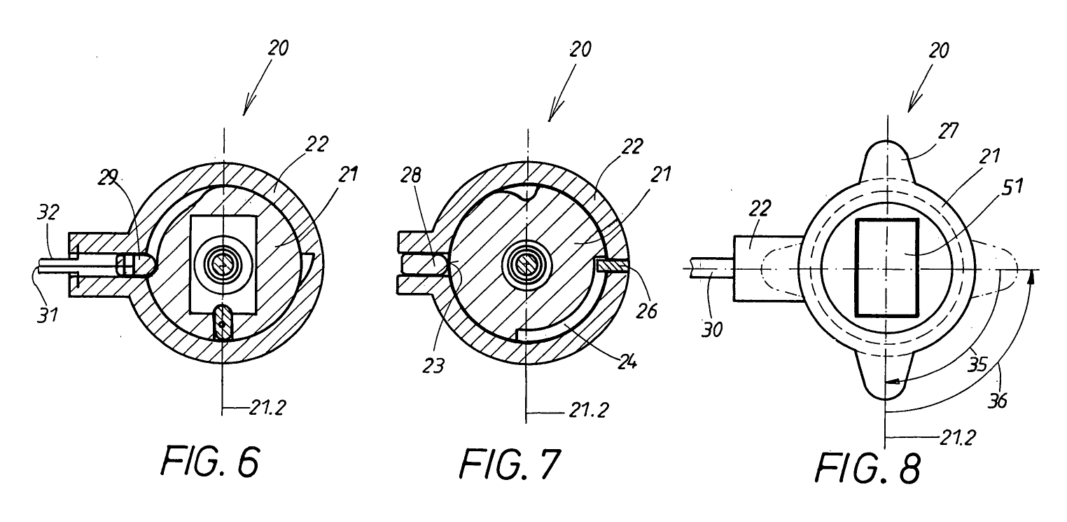

Now the rotor 21 can be turned by hand. This rotational actuation is illustrated by an arrow 35 in FIG. 8. Thus the rotor 21 arrives in the additional rotational position shown in FIGS. 5-8, which is characterized by the auxiliary line 21.2 and, as previously mentioned, is to be referred to as the “working position”. In the switch 40, which is connected nonrotatably to the rotor 21, other contacts 44, 47 are now electrically connected to each other and lead to the desired function in the associated engine of the vehicle, e.g., to the starting or operation of the engine. In the present case, the other rotational end position between the pin 26 in the stator and the groove 24 in the rotor 21 has already been reached. During the rotational actuation 35, the following additional important processes take place.

As previously mentioned, positive control is provided for the actuator blocking element 25, because the two arm ends 28, 29 always cooperate positively with their control surfaces 41, 42 and in coordination with each other. Whereas, during the above-mentioned rotational actuation 35, the first arm end 28 travels out of the radial recess 33 of FIG. 3, over the ramp and along the circumferential area 23, the other arm end 29 travels from the circumferential area 43 across a bevel into a recess 48 in the circumference of the rotor. This forces the actuator blocking element 25 to pivot around its bearing 34.

This pivoting of the actuator blocking element 25 has the effect that, by way of the above-mentioned mechanical connection 30, the other locking bar blocking element 15 is necessarily pivoted concomitantly as well and arrives in the other pivot position shown in FIG. 5. This position is characterized in FIG. 5 by the auxiliary line 15.1 and turns out to be the “active” position of the locking bar blocking element 15. That is, its locking end 18 has dropped into the locking recess 19 in the locking bar 11 and thus holds the locking bar 11 in its release position 11.2, as shown in FIG. 5. The preceding pivot position of the locking bar blocking element 15 shown in FIG. 1 is indicated by the auxiliary line 15.2, which thus characterizes the “inactive” position of the locking bar blocking element 15.

In the locking system according to the invention, the pivoted position of the actuator blocking element 25 shown in FIG. 5 and indicated by the auxiliary line 25.2 is the reason that, by way of the dimensionally stable connection 30, the locking bar blocking element 15 is in the above-mentioned active position 15.1 with respect to the locking bar 11. An arresting effect occurs. The locking bar blocking element 15 cannot be moved to the active position of FIG. 1. The reason for this is that the actuator blocking element 25 located at the other end of the connection 30 is, as shown in FIG. 5, supported by its arm end 28 on the working shoulder 23 belonging to the control surface 41. This is especially easy to see in FIG. 7.

To stop the engine, the rotor 21 must be turned by way of its handle 27 in the opposite direction indicated by the arrow 36 of FIG. 8. Then the actuator blocking element 25 pivots back out of its position 25.2 into the position illustrated by the auxiliary line 25.1 in FIG. 1. This occurs in mirror-image fashion as a result of the positive guidance function provided by the two control surfaces 41, 42 of the rotor 21 and the arm ends 28, 29 of the actuator blocking element 25. The locking bar blocking element 15 is now moved positively into the described inactive position 15.2 shown in FIG. 1 by way of the link established by the connection 30; the locking bar 11 remains temporarily in its release position 11.2 shown in FIG. 5. The locking end 18 of the blocking element thus disengages from the locking recess 19. The locking bar 11 could then be moved back out again by the previously mentioned electric motor. This, however is preferably not done until after certain additional operating conditions in the vehicle have been fulfilled. These include, individually and/or in combination, that the vehicle is actually standing still and/or that the engine is off and/or that the driver's side door has been opened and/or that a sensor has been activated and/or that a door handle has been actuated. When the actuator blocking element 25 is in pivot position 25.1, it prevents the rotor 21 from turning. This position can therefore be called its “active” position. Thus the other pivot position indicated at 25.2 in FIG. 5 turns out to be the “inactive position” of the actuator blocking element 25.

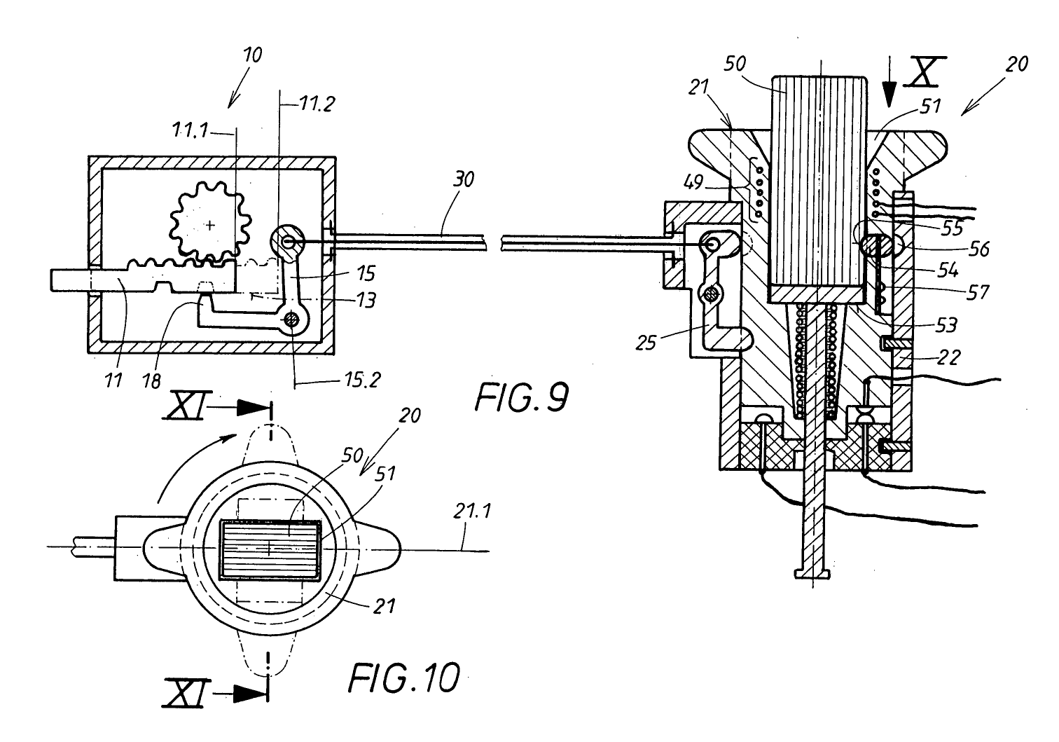

In the second exemplary embodiment of FIGS. 9-12, the locking system is designed similarly. To this extent, the previous description therefore also applies here. The difference with respect to the preceding exemplary embodiment consists in that it is assumed that the previously described “keyless-go system” has failed, which, for example, can be caused by external electromagnetic fields. But now the vehicle can be actuated by means of the emergency key 50 shown in FIG. 9-11 in similar fashion. This is accomplished in the following way.

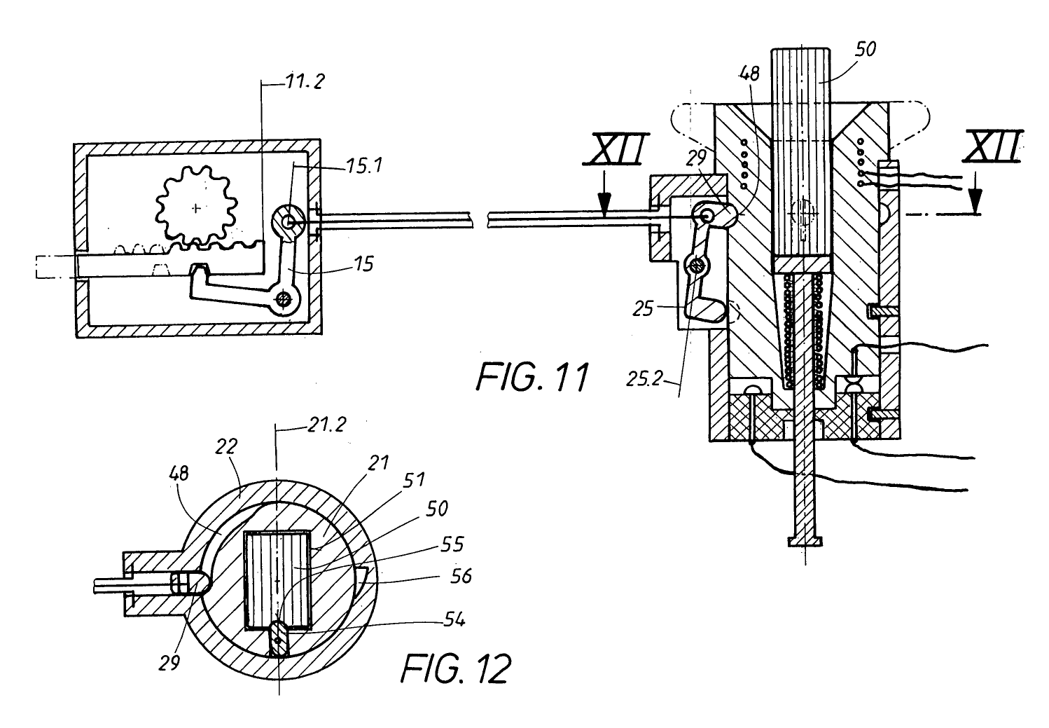

The rotor 21 shown in the first exemplary embodiment has a receptacle 51 for this type of key 50. The receptacle 51, as can be seen in FIG. 1, is usually closed by a spring-loaded cover 52, which is pushed in out of the way in elastic fashion when the key 50 is inserted. The insertion can be limited by an end stop 53 in the rotor 21 for the cover 52. Then an elastic latching means 54 can snap into a latching recess 55 in the key 50, which belongs to a key anti-pullout device. This snapping-in movement is possible because, according to FIG. 9, an escape opening 56 is located in the stator 22 in the area of the latching means 54. The electronic key 50 thus communicates with a transponder coil in the rotor 21, which coil belongs to the decoding means of the access authorization system. If the decoding is successful, the locking bar 11 is moved into the release position 11.2 indicated in dash-dot line in FIG. 9. Then the locking bar blocking element 15 is no longer supported on the locking shoulder 13, as already described in conjunction with the first exemplary embodiment. By way of the special connection 30, furthermore, the actuator blocking element 25 is rendered active at the same time and allows the rotor 21 to be turned by way of, for example, the electronic key 50. The previously described pivoting of the actuator blocking element 25 into its previously described inactive position 25.2 of FIGS. 11 and 12 thus occurs again. The coupled assembly consisting of the key 50 and the actuator 21 is then again in the previously described rotational working position 21.2. This working position is shown in FIG. 12. In this position, as already described with respect to the first exemplary embodiment in conjunction with FIG. 5, the locking bar blocking element 15 is in its active pivot position 15.1 of FIG. 11, and the key 50 is prevented from being pulled out as shown in FIG. 12. The latching means 54 of the key anti-pullout device, namely, is secured in its latching recess 55, because it is supported radially against the inside surface of the rotor 22 and is no longer radially aligned with the escape opening 56 in the stator 22. Only after the coupled assembly of key 50 and rotor 21 has been turned back into the home position 21.1, as shown in FIGS. 9 and 10, does it become possible to pull the key 50 out again.

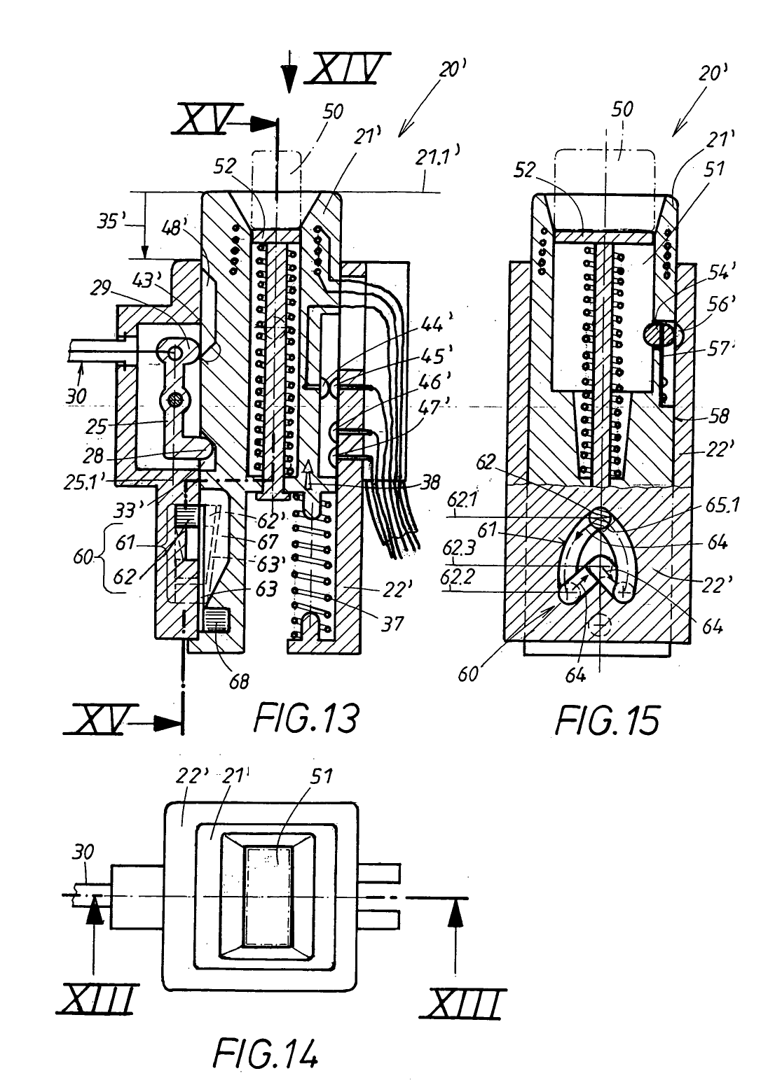

FIGS. 13-17 show a third exemplary embodiment of the invention, which, as mentioned previously in the description of the figures, is explained only with respect to the engine control unit 20′, which is designed differently here. The anti-theft lock 10 can be designed as in the first two exemplary embodiments of FIGS. 1 and 9. Parts which are the same as those of the first exemplary embodiment are designated by the same reference numbers. Parts which are analogous but designed differently are characterized by a stroke (′). It is sufficient merely to discuss the differences and additions with respect to the two preceding exemplary embodiments. Otherwise, the previous description applies here as well.

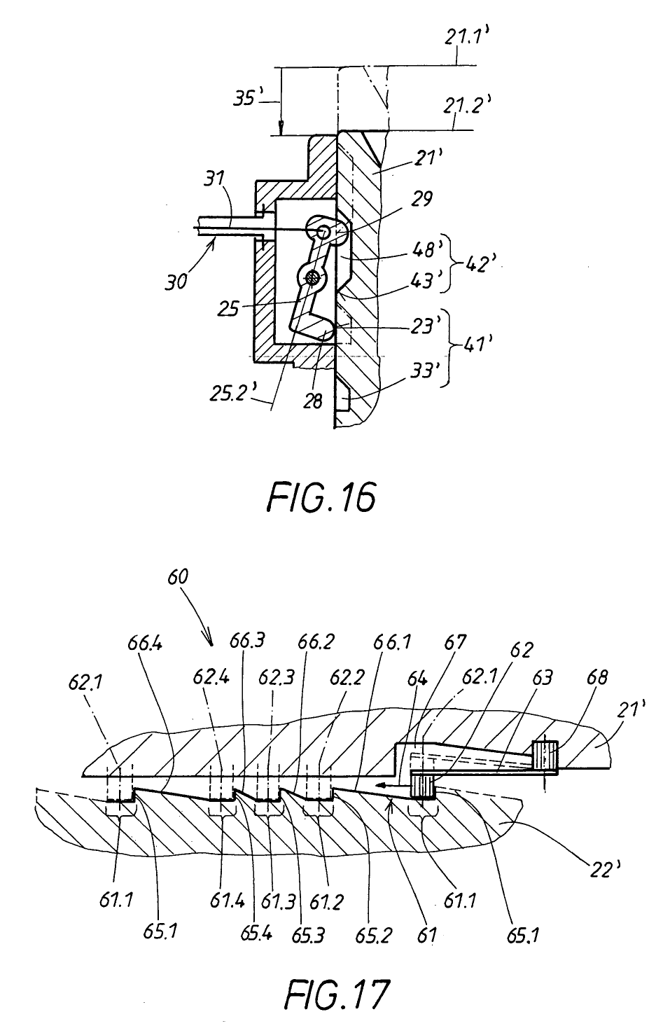

The essential difference here is that the actuator 21′ is designed as a slider, which acts in the manner of a push button, whereas the previously described rotor 21 works as a rotary knob. In this case, too, the actuation can occur in analogy to FIGS. 1-8 by means of a “keyless-go system” without keys or, in analogy to FIGS. 9-12, by means of a key (50) as indicated in dash-dot line. For this reason, the slider 21′ also has an axial receptacle 51, which again is usually closed by a spring-loaded cover 52. The slider 21′ also has two control surfaces 41′, 42′, which, according to FIG. 16, are designed as longitudinal contours but which interact in analogous fashion with the two arm ends 28, 29 of the actuator blocking element 25, which is designed here, too, in the form of a lever. This actuator blocking element 25 is now integrated into the housing of a guide 22′, which holds the slider 21′ with freedom to slide longitudinally in the direction of the arrow 35′ of FIGS. 13 and 16. A corresponding longitudinal orientation also applies, of course, to the analogous contacts 44′, 45′, 46′, and 47′ of the integrated ignition-starter switch shown in FIG. 13.

FIG. 13 shows the home position 21.1′ of the slider 21′. Here the arm end 28 of the actuator blocking element 25 engages in an opening 33′ at a defined height of the slider 21′, whereas a second arm end 29 is supported on a longitudinal edge 43′ of the slider 21′ and thus brings about here, too, the active pivot position 25.1′ described on the basis of the first exemplary embodiment. Thus the anti-theft lock 10, as shown in the analogous FIG. 1, is in a position where its locking bar blocking element 15 is in a support position of its locking bar blocking element 15 at 13, 18, as a result of which, in the present case also, the active position 25.1′ of the slider 21′ is arrested by way of the dimensionally stable connection 30, designed as, for example, a Bowden cable.

Only after, as a result of the measures described above, the electric motor has moved the locking bar 11 into its release position 11.2, shown in FIG. 5, of the first exemplary embodiment, is it possible in this third exemplary embodiment for the slider 21′ to be subjected to the above-mentioned longitudinal actuation 35′. This pushed-in position is shown in FIG. 16. The slider is then in the pushed-in working position designated 21.2′. By means of suitable, coordinated profiling of the entry and exit bevels shown on the two control surfaces 41′, 42′ of FIG. 16, the first arm end 28 of the actuator blocking element 25 travels to the longitudinal edge 23′ of the slider 21′, whereas the second arm 29 can escape into a recess 48′ at a defined axial point of the slider 21′. As a result, the actuator blocking element 25 arrives in its inactive pivot position 25.2′ of FIG. 16, as a result of which, via the strand 31 of the connection 30, the associated locking bar blocking element 15, in analogy to FIG. 5, moves into its active position 15.1 shown in FIG. 5. The working position 21.2′ of the slider 21′ of FIG. 16 is secured by a separate directional locking mechanism 60, the design of which can be seen in FIGS. 13 and 15 and in the flat curve development of FIG. 17.

The directional locking mechanism 60 includes, first, a cardioid (curve) 61, which is on the inside surface of the guide 22′. The cardioid 61 interacts with a spring-loaded control pin 62, which is connected by a leaf spring 63 at 68 to the slider 21′ so that it cannot move in the axial direction. The cardioid 61 has a sawtooth profile to determine the direction, as illustrated by the arrow 64, in which the control pin 62 can move along the closed, ring-shaped cardioid 61 of FIG. 15. Drawn in solid line is the starting position of the slider 21′, identified by the auxiliary line 62.1, in FIGS. 13, 15, and 17. The control pin 62 is now located at the station in the area of the tip of the cardioid labeled 61.1 in FIG. 17. When the slider 21′ is pushed in the direction of the arrow 35′, a first shoulder 65.1 shown in FIGS. 15 and 17 prevents the control pin 62 from moving in the “wrong” direction; it can move only in the direction of the ascending ramp 66.1 of the curve 61 in FIG. 17, therefore, in the previously mentioned direction 64. For this purpose, the slider 21′ has an escape hollow 67, into which, as illustrated in broken line in FIGS. 13 and 17, the control pin and the leaf spring 63′ can move together back into the escape position 62′.

With respect to the contacts 44′-47′, the previously mentioned position 61.1 corresponded to the “stopped” condition of the vehicle. Upon push-actuation 35′, the control pin 62 arrives first in its lowermost position, identified at 62.2 in FIG. 15, behind a second shoulder 65.2 shown in FIG. 17; this corresponds to a second station on the left flank of the cardioid in FIG. 15. Relative to the contacts 44′-47′, this position 62.2 can correspond to the “start” condition of the vehicle, i.e., to the start condition of its engine.

The slider 21′ is at all times under the action of a restoring spring 37 shown in FIG. 13, which spring exerts a restoring force 38 on the slider 21′ as indicated by the force arrow in FIG. 13. As a result, the slider 21′ tries to return to its home position 21.1′. This also occurs after the previously mentioned push-actuation, where the control pin 62 has reached the described second position 62.2. When no more manual pressure is now being exerted on the slider 21′, the control pin moves by itself from the position 62.2 into its intermediate axial position labeled 62.3 in FIGS. 15 and 17 and is then in the part of the curve designated 61.3 in FIG. 17, namely, a third station, which is in the area of the central, indented part of the curve 61. A second, stable, intermediate position of the slider 21′ has thus been reached, which corresponds to the condition “driving” of the vehicle or of its engine. The slider 21′ is then in its working position 21.2′.

Because the third station 61.3 is also blocked in the return direction by the third shoulder 65.3 shown in FIG. 17, only motion toward the third ramp 66.3 shown in FIG. 17 in the direction of the arrow 64 of FIG. 15 is possible when further push-actuation occurs. A lowermost position 62.4 of the control curve 61 is reached again behind a fourth shoulder 65.4. Then a fourth station is reached in the area of the right flank of the cardioid of FIG. 15, which is identified as 61.4 in FIG. 17. This fourth station is not stable, however, because the fourth ramp 66.4 according to FIG. 17, which points in the relaxation direction of the spring 37, follows immediately after the fourth station 61.4. When the manual pressure on the slider 21′ is released, the slider 21′ is moved onward automatically by the previously mentioned restoring force 38. The slider 21′ there arrives automatically, without any intermediate stops, in its uppermost position 62.1 at station 61.1 in the area of the tip of the cardioid. The slider 21′ is now back in its home position 21.1′ again.

During a control operation mediated by the previously mentioned key 50, the key can be inserted or withdrawn only in the home position 21.1′ of the slider 21′ in this third exemplary embodiment as well. This is achieved again by way of a spring-loaded latching means 54′ of an anti-pullout device, which is connected via the leaf spring 57′ to the slider 21′ so that it cannot move in the axial direction and which projects through an opening into the interior of the key receptacle 51. When the key is used, this latching means 54′ latches in analogous fashion in a latching recess in the key 50, as shown in FIG. 9. This latching means 54′, as illustrated in FIG. 15, is aligned with an escape opening 56′ only when the home position 21.1′ is reached. Upon the push-actuation 35′ of FIG. 16, the latching means 54′ travels along with the slider 21′ axially away from the escape opening 56′ and is supported on the inside surface 58 of the slider guide 22′ labeled 58 in FIG. 15.

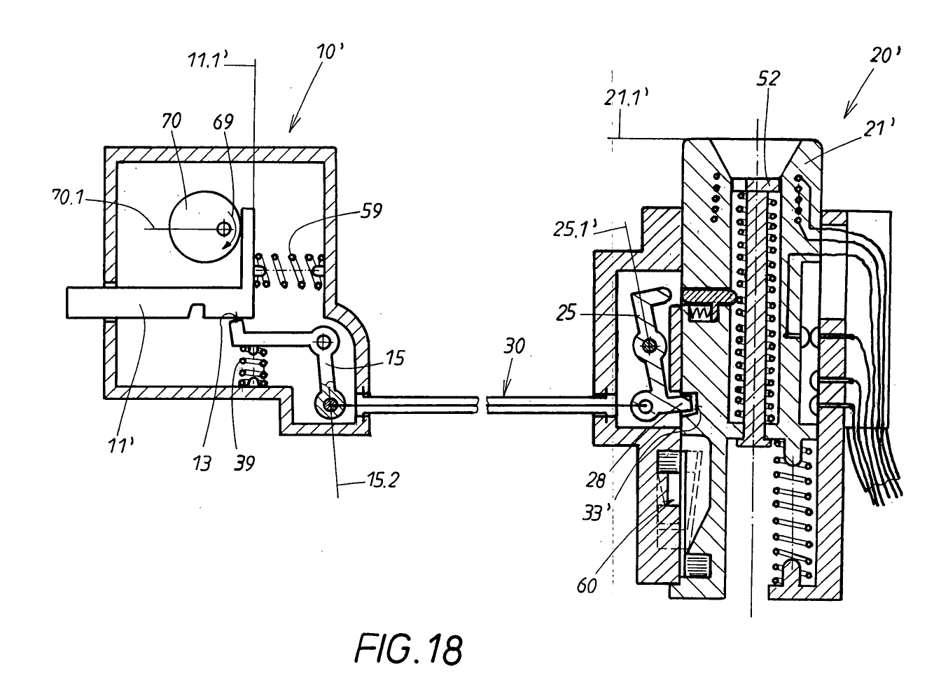

FIGS. 18-20 show a fourth exemplary embodiment of the invention, which works only with an insertable electronic key 50. In this case, the engine control unit 20′ is basically the same as that of the previously described third exemplary embodiment of FIGS. 13-17, for which reason the previous description applies here as well to the extent that the two embodiments are similar. In this case, therefore, we have again a slider 21′, which is pushed to actuate it, but here it can be actuated only by the correct key 50. The modifications explained below, however, can also be applied as appropriate to a rotor 21 which is actuated by turning according to the first two exemplary embodiments of FIGS. 1-12. The anti-theft lock 10′ is designed in a manner different from that of the preceding exemplary embodiments. Although similar parts therefore bear the same reference numbers as those of the previously described anti-theft lock 10, an apostrophe (′) is provided after them for the sake of differentiation. The blockade elements 15, 25 on the two sides and the connection 30 between them are essentially the same as those of the preceding exemplary embodiments, for which reason reference can be made to this extent to the preceding description. It is sufficient to discuss only the differences here.

FIG. 18 shows a situation similar to that of FIG. 1. Although the slider 21′ is in its axial home position 21.1′, the key has not yet been inserted. In this case, too, the locking bar blocking element 15 is supported in the locking position 11.1′ of the locking bar 11′ against a locking shoulder 13 and is the reason that, by way of the connection 30, the actuator blocking element 25 is in its active position 25.1′, in which its first arm 28 engages in the recess 33′ and thus arrests the home position 21.1′ of the slider 21′. This is true, even though the locking bar blocking element 15, which is in its inactive position 15.2 in FIG. 18, is being subjected to the force of a restoring spring 39, which tries to move it into its active position. To arrive in its active position 15.1, the locking bar blocking element 15, as seen in FIG. 18, would have to be able to pivot in the clockwise direction, but because it is supported against the locking shoulder 13, this is not possible just now.

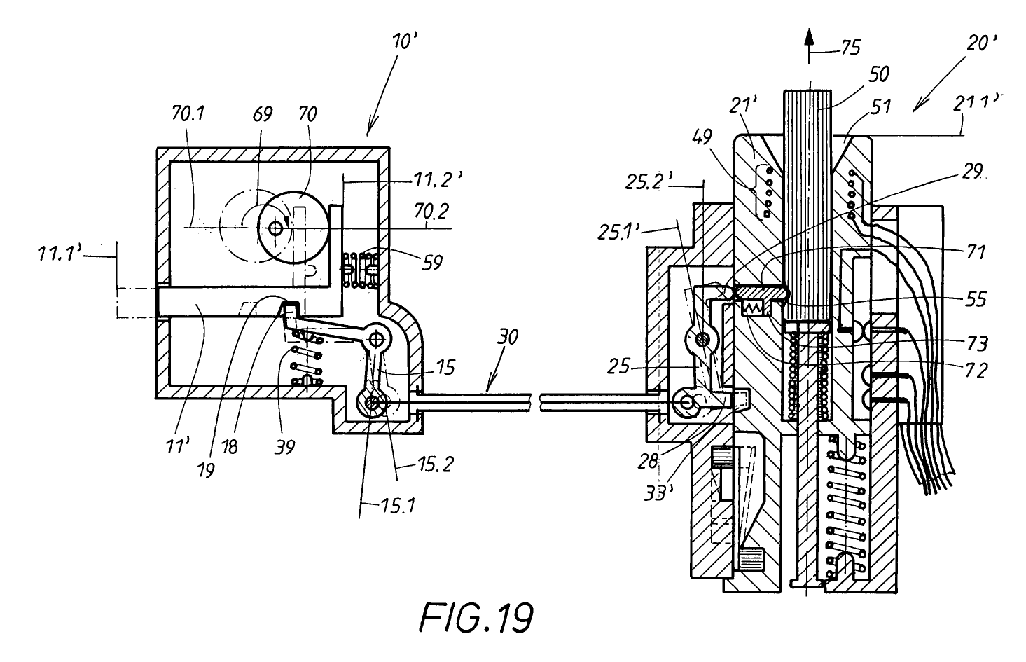

When, according to FIG. 19, the key 50 is inserted into the receptacle 51 of the slider 51′, the interaction between the key and the transponder 49 will allow the access authorization unit to confirm that the correct key 50 belonging to the vehicle is present. The authorization unit will then cause an electric motor to reverse a cam 70 in such a way that the locking bar 11′ is moved against the action of a locking bar restoring spring 59 into its release position 11.2′ shown in FIG. 19. Then, however, the locking end 18 of the locking bar blocking element 15 is aligned with a locking recess 19 in the locking bar 11′, into which it is pressed by its restoring spring 39. The locking bar blocking element 15 then arrives in its active position 15.1 and carries the actuator blocking element 25 along with it by way of the connection 30. As a result, this second blocking element also moves out of its active position 25.1′, which was present up until then and is shown in dash-dot line in FIG. 19, and into the inactive position 25.2′ shown in solid line. As FIG. 19 also shows, the arm end 28 is now outside the recess 33′ and therefore allows the slider 21′ to be pushed. Simultaneously, the key 50 and the slider 21′ latch together. This is accomplished by a plunger 71, which a plunger spring 72 tries to push into a latching recess 55 in the key 50. The plunger 71 has a shoulder 73, which serves not only as a surface against which the plunger spring 72 can act but also simultaneously as an end stop, which limits the longitudinal movement of the plunger 71. In FIG. 19, it is therefore now possible to push the slider 21′ to actuate it.

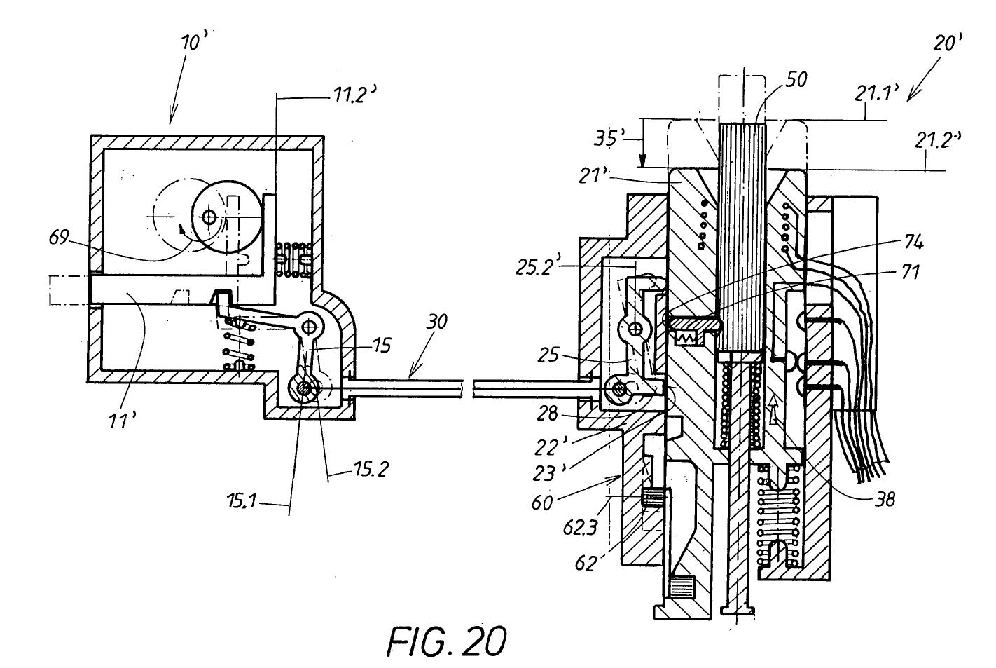

This push-actuation 35′ has been completed in FIG. 20, and the slider 21′ is now out of its home position 21.1′, still indicated here in dash-dot line, and in its working position 21.2′. These slider positions are again maintained by the previously described directional locking mechanism 60, which is designed in the manner described in conjunction with the third exemplary embodiment. In FIG. 20, the described control pin 62 is now in its intermediate position 62.3 again in the area of the indented portion of the cardioid 61. Although the slider 21′ is still under the action of its restoring force 38, this force cannot have any effect. The key 50 is held in its inserted position in the slider 21′, because the plunger 71 is holding it there, and the plunger 71 has become immobilized. The latter is true because the outer end of the plunger is supported against an inside surface 74 of the slider guide 22′ present there.

Also important is the special way in which the locking bar blocking element 15 is arrested. The locking bar 11′ is secured in its release position 11.2′ by the actuator blocking element 25 provided on the engine control unit 20′. In FIG. 20, the blocking element 25 is still in the inactive position 25.2′ described in connection with FIG. 19. Because, in FIG. 20, the first arm end 28 is supported against a longitudinal contour 23′, this inactive position 25.2′ is secured. As a result, it is impossible for the actuator blocking element 25 to perform the pivoting movement in the counterclockwise direction required for it to reach its active position, indicated there in dash-dot line. By way of the connection 30, therefore, it is also impossible in the anti-theft lock 10′ for the locking bar blocking element 15 to perform the pivoting movement in the counterclockwise direction required for it to move out of its active position 15.1 shown there in solid line and into the inactive position 15.2 shown-in dash-dot line.

As a result of the renewed push-actuation of the assembly consisting of the key 50 and the slider 21′, the home position 21.1′ of FIG. 19 is reached again by way of the previously described cardioid (curve) 61 of the directional locking mechanism 60. By way of the electronic control circuit (not shown), it is then possible for the electric motor to move the cam 70 back from its pushed-in rotational position, still present initially, shown in solid line and marked by the auxiliary line 70.2, into the opposite, released rotational position shown here and also in FIG. 19 in dash-dot line, this position being marked by the auxiliary line 70.1 in agreement with FIG. 19. The electric motor can continue to rotate the cam 70 in the same direction 69 as it did in the preceding case between the positions of FIG. 18 and FIG. 19. Then, although the locking bar restoring spring 59 tries to move the locking bar 11′ back again out of the release position 11.2′, this is not possible, because the locking end 18 of the locking bar blocking element 15 is still engaged in the locking recess 19 in the locking bar 11′.

The release position 11.2′ remains preserved until the key 50 has been pulled out of the slider 21′. According to FIG. 19, the plunger 71 is supported against the second arm end 29 of the actuator blocking element 25, but is no longer locked as in FIG. 20. The key can therefore be pulled out from the slider 21′ in the direction of the arrow 25 of FIG. 19. As this happens, the inner end of the plunger 71 travels out of the latching recess 55 in the key and causes the plunger 71 to move longitudinally against the force of its plunger spring 72. This is possible in FIG. 19, because the first arm end 28 of the actuator blocking element 25 is now aligned again with the recess 33′ in the longitudinal edge of the slider 21′. By means of this longitudinal movement of the plunger 71, not only the actuator element 25 is pivoted back into its effective position 25.1′, indicated in dash-dot line in FIG. 19, but also, by way of the connection 30, the locking bar blocking element 15 is also moved into its inactive position 15.2. Thus the locking end 18 travels out of the locking recess 19 in the locking bar 11′, and the locking bar 11′ can move back again under the action of the locking bar restoring spring 59 into its locking position 11.1′, shown in dash-dot line in FIG. 19, with respect to a steering column (not shown). Then the situation is the same as that of FIG. 18 again.

While specific embodiments of the invention have been shown and described in detail to illustrate the inventive principles, it will be understood that the invention may be embodied otherwise without departing from such principles.

1. A locking system for motor vehicles, comprising
a device for driving authorization;
an actuator for controlling the engine, the actuator being manually movable between a home position associated with a parked state of the vehicle and at least one working position associated with a state in which the vehicle is being driven;
an actuator blocking element for normally securing the actuator in the home position thereof;
a locking bar for an anti-theft lock of the vehicle acting on a steering column, the locking bar being switchable between a release position and a locking position; and
a locking bar blocking element for securing the locking bar in the release position thereof; further comprising
a connection between the actuator blocking element and the locking bar blocking element for rendering the locking bar blocking bar element active when the actuator blocking element is inactive and, conversely, for rendering the locking bar blocking element inactive when the actuator blocking element is active;
wherein, when the locking bar is in the locking position, the locking bar blocking element is supported against a locking shoulder of the locking bar, and,
wherein the locking bar blocking element causes by means of the connection the active position of the actuator blocking element, which holds the actuator in the home position thereof, to remain arrested.

2. The locking system according to claim 1, wherein the locking shoulder is configured to be movable together with the locking bar when the position of the locking bar is reversed, and wherein, when the locking bar is in the release position, the locking shoulder is located at a certain distance from the locking bar blocking element.

3. The locking system according to claim 2, wherein, when the actuator is in the working position, the actuator blocking element is supported on a working shoulder of the actuator, and wherein the actuator blocking element causes by means of the connection the active position of the locking bar blocking element, which holds the locking bar in the release position, to remain arrested.

4. The locking system according to claim 3, wherein the working shoulder is comprised of a contour on the actuator which moves together with the actuator and is located a certain distance away from the actuator blocking element when the actuator is in the home position.

5. The locking system according to claim 1, wherein the actuator is comprised of a rotor, which is held with freedom of rotation in a stationary stator, wherein the actuator blocking element is integrated into the stator, and wherein the rotor has a control surface for the actuator blocking element, the control surface being configured as a circumferential contour into which the working shoulder is integrated.

6. The locking system according to claim 5, wherein the rotor comprises a handle for turning and actuating the rotor.

7. The locking system according to claim 5, wherein the device for driving authorization comprises a mobile part in the possession of an authorized person and a stationary part installed in the vehicle, wherein the mobile part is a coded insertable element, and wherein the rotor has a receptacle for receiving the coded insertable element, wherein decoding means of the stationary part are provided in the area of the receptacle.

8. The locking system according to claim 7, wherein, after the insertable element has been inserted into the rotor, the insertable element forms the handle of the rotor.

9. The locking system according to claim 7, comprising an anti-pullout lock for the insertable element provided between the rotor and the stator, and wherein the anti-pullout lock is configured to allow the insertable element to be pulled out of the rotor only when the rotor is in the rotational position associated with the home position.

10. The locking system according to claim 3, wherein the actuator comprises a slider received with freedom of longitudinal movement in a stationary guide, wherein the actuator blocking element is integrated into the stationary guide, and wherein the slider has at least one control surface formed as a longitudinal contour, wherein the working shoulder is integrated into the control surface.

11. The locking system according to claim 10, wherein the slider is a push-type actuator and is axially spring-loaded in the direction toward the home position.

12. The locking system according to claim 10, wherein the device for driving authorization comprises a mobile part in the possession of an authorized person and a stationary part installed in the vehicle, wherein the mobile part is a coded insertable element and wherein the slider has a receptacle for receiving the insertable element, wherein decoding means of the stationary part are provided in the area of the receptacle.

13. The locking system according to claim 12, wherein, after the insertable element has been inserted into the slider, the insertable element simultaneously acts to push and actuate the slider.

14. The locking system according to claim 12, comprising an anti-pullout lock for the insertable element provided between the slider and a guide of the slider, and wherein the anti-pullout lock is configured to allow the insertable element to be pulled out of the slider only in an axial position associated with the home position.

15. The locking system according to claim 7, wherein, when the insertable element is pulled out of the rotor, the connection causes the locking bar blocking element to be inactive and the locking bar to be released.

16. The locking system according to claims 1, comprising a motor gear system for switching the locking bar from the locking position to the release position, wherein the locking bar acts with fricitonal engagement on an output of the gear system, and wherein the locking bar is spring-loaded in a direction towards the locking position and/or the locking bar blocking element is spring-loaded in a direction towards the active position.

17. The locking system according to claims 1, comprising a motor gear system for switching the locking bar from the locking position to the release position, wherein the locking bar positively engages an output of the gear system.

18. The locking system according to claim 1, wherein the connection between the actuator blocking element and the locking bar blocking element is comprised of a Bowden cable.

19. The locking system according to claims 10, comprising a directional locking system provided between the slider and the guide for the slider, wherein the directional locking mechanism is comprised of a ring-like closed cardioid on the guide having a sawtooth profile, and a control pin on the slider, wherein the control pin is spring-loaded toward the sawtooth profile.

20. The locking system according to claims 5, wherein resting and moving contacts of an ignition-starter switch are integrated between the rotor and the stator.
